(19) United States
(12) Patent Application Publication
(10) Pub. No.: US 2026/0251279 A1
(43) Pub. Date: Aug. 27, 2026

(54) LIGHTING DEVICE FOR A MOTOR VEHICLE

(71) Applicant: HELLA GMBH & CO. KGAA, Lippstadt (DE)

(72) Inventors: Bernd Fischer, Altenbeken (DE); Julian Grote, Borchen (DE); Martin Mügge, Geseke (DE); Julian Schwinn, Soest (DE)

(21) Appl. No.: 19/544,414

(22) Filed: Feb. 19, 2026

(30) Foreign Application Priority Data
Feb. 21, 2025 (DE) 102025106708.2

(51) Int. Cl. F21S 43/241; F21S 43/14; F21S 43/20; F21S 43/249; F21S 43/30; F21W 103/20; F21W 103/55

(52) U.S. Cl. CPC F21S 43/241; F21S 43/14; F21S 43/2492; F21S 43/26241; F21S 43/26271; F21S 43/2643; F21S 43/30; F21W 2103/20; F21W 2103/55

(57) ABSTRACT

The present invention relates to a lighting device for a motor vehicle. The lighting device includes a first light-generating device, which has at least one first light source, a planar light guide with at least one entry surface and at least one exit surface, at least one optical component, and a cover lens. The light generated by the first light source enters the light guide through the entry surface and exits from the at least one exit surface. The light exiting from the exit surface passes through the optical component, is reflected by the optical component, or both. The light exiting from the exit surface of the light guide exits from the lighting device through the cover lens. The lighting device includes a second light-generating device with at least one second light source, wherein the light emitted by the second light-generating device exits the lighting device through the cover lens.

### CROSS-REFERENCE TO RELATED APPLICATIONS

This application claims the benefit of German Patent Application 10-2025-106-708.2, filed Feb. 21, 2025, the disclosure of which is incorporated by reference in its entirety.

### FIELD OF THE INVENTION

The present invention relates to a lighting device for a motor vehicle.

### BACKGROUND OF THE INVENTION

Design has long been a determining factor for the signal functions of a motor vehicle, such as a tail light, a brake light, a turn signal, or a daytime running light, in rear lamps or in headlamps. The design of these lighting devices has become even more significant since the introduction of LED technology, because the small light-emitting diodes, which are often used in larger numbers, can be used as a light source for a signal function much more flexibly than a large incandescent lamp, so that a wide variety of design options are available in conjunction with the selected optical system.

A variant of LED technology is found in the form of OLED technology, in which the light source is not small and point-like as a light-emitting diode, but rather designed to be planar and larger to form a desired light-emitting surface that can be illuminated very homogeneously. A disadvantage of OLED technology is the significantly higher cost of OLED technology compared to LED technology. The reasons for these high costs are a complex manufacturing process, the different shapes dictated by the design and small quantities. In addition, there are specific, high requirements in the automotive sector, such as resistance to UV exposure and the effects of forces such as vibrations, impacts, and shaking, as well as temperature resistance in a range between −40° C. and +85° C. or +100° C. These requirements are substantially more difficult to meet for an organic light-emitting diode than for standard light-emitting diodes.

As a result, alternative options are being sought to achieve a design similar to that of organic light-emitting diodes (OLEDs), in particular a homogeneously illuminated surface. This is achieved by using light-emitting diodes (LEDs) with a planar light guide and upstream optics in the form of microstructured films or thin optical disks, to scatter the light emitted from the light guide. Overall, this provides a flat light module that offers high performance with homogeneous illumination of the entire surface.

Just as with organic light-emitting diodes, several flat light modules can then be positioned offset next to and behind one another when integrated into a rear lamp, in order to create the desired individual appearance of the signal function, for example, of the tail light or the tail/brake light. Finally, a flat light module instead of individual modules can also be designed as a large flat lighting element. As such a flat lighting device, it can also be used to backlight displays.

A lighting device of the type mentioned at the beginning, designed as a flat light module, is known from DE 10-2022-113-052 A1. The lighting device described therein comprises at least one light source designed as a light-emitting diode (LED) and a flat light guide with an entry surface and at least one exit surface, the entry surface being designed as the front surface of the light guide. The lighting device further comprises at least one optical disk. The lighting device is configured such that the light generated by the at least one light source enters the light guide at least partially through the entry surface, so that the light that has entered through the entry surface exits at least partially from the at least one exit surface, and so that the light exiting from the at least one exit surface of the light guide passes at least partially through the at least one optical disk. In this case, the flat light module can have LEDs of different colors, such as red, yellow, or white, in order to achieve a combination of signal functions, such as a tail/brake/turn light or an additional reverse light.

An exemplary lighting device designed as a flat-light module according to this prior art is shown in FIG. 16 and FIG. 17. This flat light module comprises a light source 1 that has several light-emitting diodes (LEDs). The flat light module also comprises a housing 2 with a rear housing part and a front housing part 2a, 2b, which are connected to one another by a latching mechanism. A plate-shaped light guide 3 with micro-optics, a white, diffusely reflective film 4 behind the light guide 3, and two or three optical components 5a, 5b designed as micro-optical films in front of the light guide 3 are inserted between the housing parts 2a, 2b, which together are responsible for the light distribution and efficiency of the system by coordinating the individual micro-optical components with one another. The principle of this basic structure is to provide a lighting element with a uniform, homogeneously illuminated surface. For this purpose, the lighting device comprises a cover lens 6, which serves as the illuminated exit surface of the lighting device.

The optical component 5a adjacent to the light guide 3 is designed as a diffuser, whereas the second optical component 5b is designed as a so-called BEF optical system. BEF in this context means “Brightness Enhancement Film”. The BEF optics therefore serve to increase the brightness of the light passing through the optical component 5b. The BEF optics can be realized on a film or also as a thin injection-molded optical disk. Systems with two BEF optics, oriented orthogonally to one another, can also be provided, wherein the diffuser optics are sometimes omitted.

In the prior art, flat light modules of this type are intended to form a completely luminous, one-piece surface as a module of a small size or any desired size up to a larger surface of a rear lamp or of the entire rear lamp. With flat light modules from the prior art, the focus of implementation is primarily on planar luminous surfaces or surfaces with a slight curvature in one direction, such as a cylindrical surface.

Even if a flat light module is designed in itself to generate a signal function with higher light intensities, such as, for example, a brake light, or a turn signal, or a daytime running light, there may still be unfavorable geometric designs of the flat light module, especially in the case of a possibly three-dimensionally designed light guide of the flat light module, which make it impossible to implement such a signal function alone.

### SUMMARY OF THE INVENTION

The problem underlying the present invention is the creation of a lighting device of the type mentioned in the beginning, in which the generation of a signal function with higher light intensities is made possible despite a possibly unfavorable geometric design, in particular of the light guide.

This is achieved by a lighting device of the type mentioned in the beginning with the characterizing features of the current embodiments.

In one embodiment, it is provided that the lighting device comprises at least one second light-generating device having at least one second light source, wherein the lighting device is configured such that the light emitted by the at least one second light-generating device exits the lighting device through the cover lens. This measure allows a first light-generating device, which is designed in particular as a flat light module, which in particular has a light guide with a three-dimensionally curved surface or with another unfavorable design, such as, for example, an extremely twisted installation position, to be combined with a second light-generating device and operated together. In this case, the lighting device can be configured such that the first light-generating device generates at least one first signal function, such as, for example, a position light, and that the second light-generating device generates at least one second signal function, such as, for example, a daytime running light or a turn signal. In particular, the at least one second signal function is the signal function that requires higher light intensities.

It is possible that the second light-generating device has at least one lens, in particular a Fresnel lens, preferably a Fresnel lens designed as a Typhoon lens, wherein the lighting device is configured such that the light generated by the at least one second light source passes through the at least one lens before it exits the lighting device through the cover lens. Alternatively or additionally, it may be provided that the second light-generating device has at least one reflector, wherein the lighting device is configured such that the light generated by the at least one second light source passes through the at least one reflector before it exits the lighting device through the cover lens. Alternatively or additionally, it may be provided that the second light-generating device has at least one light guide, wherein the lighting device is configured such that the light generated by the at least one second light source passes through the at least one light guide before it exits the lighting device through the cover lens. Each of the three different embodiments can be configured such that the second light-generating device provides the high light intensity required for the at least one second signal function.

It is possible for the cover lens to have micro-optics and/or a diffuser structure, wherein the lighting device is configured such that both the light emitted by the first light-generating device and the light emitted by the second light-generating device pass through the micro-optics and/or the diffuser structure. By positioning the different signal functions behind a structured cover lens, a uniform appearance is achieved for the observer. In particular, this design can be realized both as a rear lamp and as a headlamp. The new approach of incorporating micro-optics and/or diffuser structures into the cover lens is also advantageous in terms of sustainability, because it eliminates the need for an additional internal lens, for which no tools are then required, as well as reduces development effort and simplifies assembly of the entire headlamp.

It may be provided that the light guide has curvatures in two different directions, in particular, in two mutually perpendicular directions, wherein preferably the surface of the light guide is curved at least in sections in two different directions, in particular, in two mutually perpendicular directions. This results in a three-dimensionally curved surface, which makes it easier to integrate the lighting device into a curved design of the motor vehicle.

It is possible that the light guide has a structuring, in particular a micro-optical structuring, on its surface opposite the at least one exit surface, which can cause or amplify a decoupling of the light that has entered through the at least one entry surface from the at least one exit surface, in particular, wherein the structuring has a density distribution, wherein the density of the structuring on the surface opposite the at least one exit surface increases with increasing distance from the at least one entry surface. Such a design ensures that a uniform intensity of the decoupled light is achieved over the longitudinal extent of the light guide.

It may be provided that the light guide is substantially U-shaped, at least in sections, wherein the light guide has two U-legs and a connecting portion that connects the U-legs to one another, in particular, wherein the two U-legs are spaced apart from one another. In this case, each of the U-legs of the light guide can have, in sections, a longitudinal direction and a transverse direction perpendicular thereto, as well as a depth perpendicular to the longitudinal direction and to the transverse direction, in particular, wherein each of the U-legs of the light guide has a greater extent in the longitudinal direction than in the transverse direction and a greater extent in the transverse direction than in the depth perpendicular to the transverse direction, so that each of the U-legs of the light guide has an end surface at the end in the longitudinal direction, two narrow surfaces extending in sections in the longitudinal direction, and two wide surfaces extending in sections in the longitudinal direction.

It is possible for the light guide to have at least two entry surfaces, wherein at least one of the entry surfaces is arranged on each of the U-legs. In this case, one of the entry surfaces can be arranged in each case on the end surface of the U-leg facing away from the connecting portion and/or one of the entry surfaces can be arranged in each case on the narrow surfaces extending in the longitudinal direction of the U-leg. Depending on the desired design, the shape, and the size of the exit surface of the light guide, one of the two possibilities for coupling can be selected. In particular, it is also possible to arrange entry surfaces for the light to be coupled into the light guide both on the end surfaces of the U-legs facing away from the connecting portion and on the narrow surfaces of the U-legs extending in the longitudinal direction of the U-leg.

It may be provided that the second light-generating device is arranged in the lighting device such that, during operation of the lighting device, the light emitted by the second light-generating device passes between the two U-legs of the light guide before it strikes the cover lens. This design means that the first light-generating device, which is designed in particular as a flat-light module, forms a luminous frame as a horizontal U-shaped element, wherein with the signal function of the second light-generating device arranged between the two U-legs.

It is possible for the at least one optical component to be designed as a microstructured film and/or as a microstructured optical disk, wherein the at least one microstructured film or the at least one microstructured optical disk is arranged in particular between the light guide and the cover lens. Furthermore, it may be provided that the light guide has at least two exit surfaces, wherein a first of the exit surfaces faces away from the cover lens and a second of the exit surfaces faces the cover lens, wherein the at least one optical component is designed as an at least partially reflective surface that is arranged on the side of the light guide facing away from the cover lens, wherein the lighting device is configured such that light emerging from the first exit surface of the light guide strikes the reflective surface, is reflected back from the latter to the first exit surface, and at least partially re-enters the light guide before exiting from the second exit surface and passing through the at least one cover lens. In this way, as with a flat light module, the lighting device can provide high performance with homogeneous illumination of the cover lens by reflecting the light exiting from the light guide at the rear and/or by targeted scattering on the microstructured films and/or optical discs.

### BRIEF DESCRIPTION OF THE DRAWINGS

The invention is explained in more detail below with reference to the accompanying figures. In the figures:

FIG. 1 is a front view of a first embodiment of a lighting device according to an embodiment of the invention, in which different light functions are indicated;

FIG. 2 is a sectional view through the lighting device according to FIG. 1;

FIG. 3 is a front view of the parts of the lighting device according to FIG. 1 that generate the signal functions;

FIG. 4 is a perspective view of the parts of the lighting device according to FIG. 1 that generate the signal functions;

FIG. 5 is a top view of the parts of the lighting device according to FIG. 1 that generate the signal functions;

FIG. 6 is a detailed view according to arrow VI in FIG. 5;

FIG. 7 is a detailed view according to arrow VII in FIG. 5;

FIG. 8 is a rear view of the parts of the lighting device according to FIG. 1 that generate the signal functions;

FIG. 9 is a rear view of the parts of the lighting device according to FIG. 1 that generate the signal functions with a cover lens and a housing;

FIG. 10 is a rear view of the parts of the lighting device according to FIG. 1 that generate the signal functions with the cover lens, the housing, and a rear cover;

FIG. 11 is a top view, corresponding to FIG. 5, of the parts of the lighting device according to FIG. 1 that generate the signal functions with a density distribution of a structuring;

FIG. 12 is a front view of the lighting device according to FIG. 1, corresponding to FIG. 1, in which only the signal light functions are indicated;

FIG. 13 is a front view, corresponding to FIG. 1, of a second embodiment of a lighting device according to the invention, in which different light functions are indicated;

FIG. 14 is a front view, corresponding to FIG. 1, of a third embodiment of a lighting device according to the invention, in which different light functions are indicated;

FIG. 15 is a front view, corresponding to FIG. 1, of a fourth embodiment of a lighting device according to the invention, in which different lighting functions are indicated;

FIG. 16 is a perspective view of a lighting device according to the prior art; and

FIG. 17 is an exploded view of the lighting device according to FIG. 16.

In the figures, identical or functionally identical parts are indicated with the same reference signs.

### DETAILED DESCRIPTION OF THE CURRENT EMBODIMENTS

The illustrated embodiments of a lighting device are designed as headlamps of a motor vehicle. However, it is also possible to use similar geometries in the same way for rear lamps or interior lights.

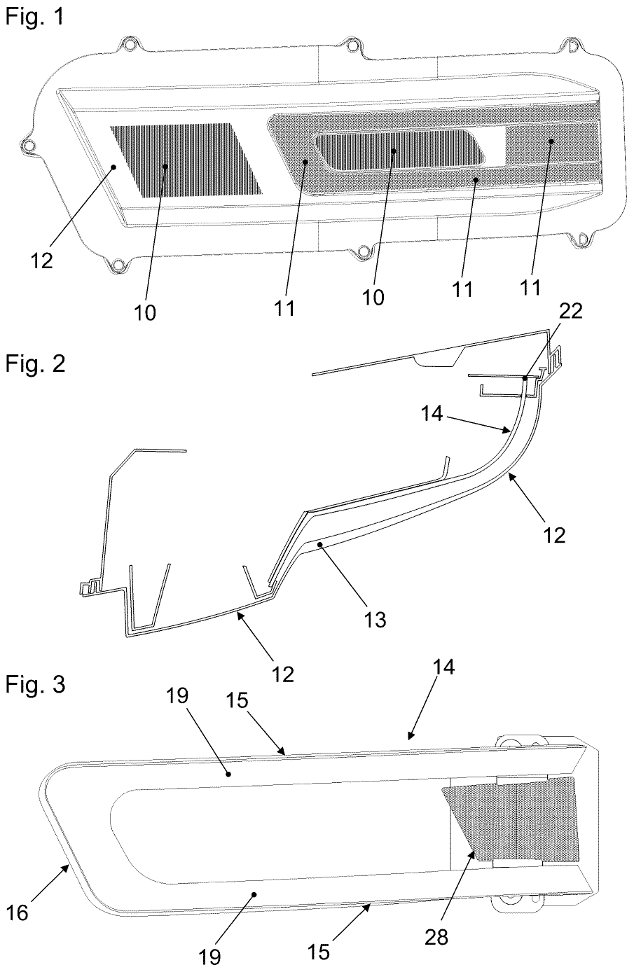

In the lighting device designed as a headlamp, regions 10 are provided for the main light functions of low beam and high beam, and regions 11 are provided for the signal functions of a common position light, daytime running light, and turn signal (see FIG. 1).

The lighting device comprises a cover lens 12, which has a recess 13 in a partial region of the cover lens 12 (see FIG. 2). A light guide 14 is arranged behind the cover lens 12, and runs parallel to the cover lens 12, at least in sections. The light guide 14 has curvatures in two different directions, in particular, in two mutually perpendicular directions.

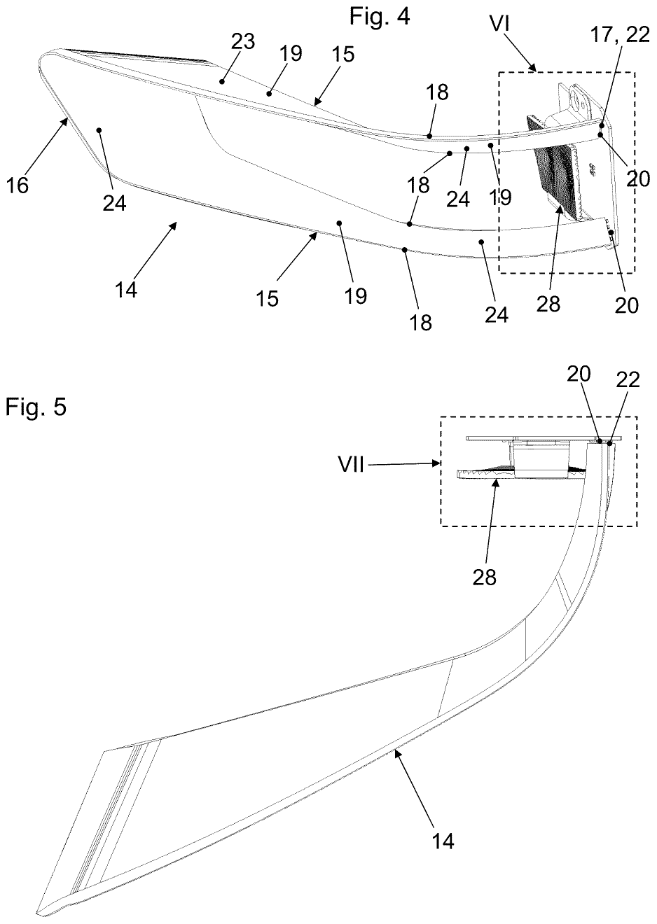

The light guide 14 is designed to be at least substantially in a U-shape, wherein the light guide 14 has two U-legs 15 and a connecting portion 16, which connects the U-legs 15 to each other (see FIG. 3 and FIG. 4). In this case, the two U-legs 15 are spaced apart. Each of the U-legs 15 of the light guide 14 has, in sections, a longitudinal direction and a transverse direction perpendicular thereto, as well as a depth perpendicular to the longitudinal direction and to the transverse direction. Thereby, each of the U-legs 15 of the light guide 14 has a greater extension in the longitudinal direction than in the transverse direction, and a greater extension in the transverse direction than in the depth perpendicular to the transverse direction (see FIG. 4). Therefore, each of the U-legs 15 of the light guide 14 has an end surface 17 at the end in the longitudinal direction, two narrow surfaces 18 extending in sections in the longitudinal direction, and two wide surfaces 19 extending in sections in the longitudinal direction.

The lighting device has a plurality of first light sources 20 configured in the form of light-emitting diodes (see FIG. 4). The light 21 emitted by these first light sources 20 is coupled into the light guide 14. In the illustrated embodiments, the two end faces 17 of the U-legs 15 serve as entry surfaces 22 for the light 21.

In this case, four first light sources 20 are assigned to each of the U-legs 15 such that the light emitted by the first light sources 20 enters the entry surface 22. Therefore, two of the four first light sources 20, which are assigned to one of the U-legs 15, are designed as white light-emitting diodes and two further of the four first light sources 20 are designed as yellow light-emitting diodes.

Alternatively, it is quite possible that the two narrow surfaces 18 of the U-legs 15, which extend in sections in the longitudinal direction, serve as entry surfaces 22 for the light 21 emitted by the first light sources 20. It is certainly possible to use both the end surfaces 17 of the U-legs 15 and the narrow surfaces 18 of the U-legs 15 as entry surfaces 22 for the light 21 emitted by the first light sources 20.

The light guide has two exit surfaces 23, 24, wherein the first exit surface 23 faces away from the cover lens 12, and the second exit surface 24 faces the cover lens 12. In this case, the wide surfaces 19 of the U-legs 15, which extend in sections in the longitudinal direction, and the front and rear side of the connecting portion 16 serve as exit surfaces 23, 24 for the light 21 coupled into the light guide 14 through the entry surfaces.

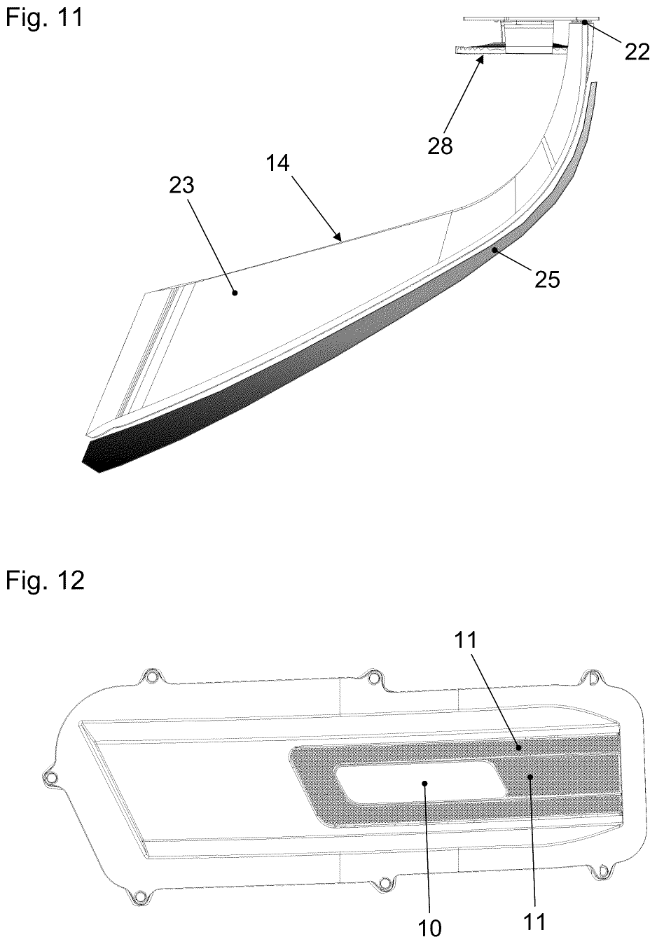

A micro-optical structuring is arranged on the first exit surface 23 facing away from the cover lens, which can cause or amplify the decoupling of the light 21 that has entered through the entry surfaces 22 from the second exit surface 24. The structuring has a density distribution 25, wherein the density of the structuring on the first exit surface 23 increases with increasing distance from the entry surfaces 22. In this context, density refers to the number of micro-optics per unit area. The density distribution 25 is shown schematically in FIG. 11.

The lighting device also comprises an optional optical component, not shown, which is designed as an at least partially reflective surface. This optical component is arranged on the side of the light guide 14 facing away from the cover lens 12. In this case, the lighting device is configured such that light 21 emitted from the first exit surface 23 of the light guide 14 strikes the reflective surface of the optical component, is reflected back from the latter to the first exit surface 23, and at least partially re-enters the light guide 14 before it emerges from the second exit surface 24 and passes through the cover lens 12.

The lighting device further comprises at least one optional optical component, not shown, which is designed as a microstructured film or as a microstructured optical disk. The at least one microstructured film or the at least one microstructured optical disk is arranged between the light guide 14 and the cover lens 12.

The lighting device further comprises a housing 26, in or on which the light sources 20, the light guide 14, and the cover lens 12 and, if applicable, the optical components, are arranged (see FIG. 9 and FIG. 10). In this case, a rear cover 27 is also provided on the side of the light guide 14 facing away from the cover lens 12.

The first light sources 20, the light guide 14, and the at least one optical component are part of a first light-generating device. This first light-generating device is used to generate a first signal light function, which can be a position light, for example. Due to the three-dimensional surface of the light guide 14 and the overall unfavorable geometry caused by the funnel-shaped recess, the circumferential surface of the cover lens 12 is homogeneously backlit or illuminated by the light guide 14, but, also due to the limited number of first light sources 20 arranged on the lateral entry surfaces 22, can provide only a position light with a lower luminous intensity requirement, but cannot fulfill a daytime running light or a turn signal with a much higher luminous intensity requirement.

Therefore, in addition to the first light-generating device, the lighting device comprises a second light-generating device 28 (see FIG. 4). The second light-generating device 28 is used to generate a second signal light function, which can be, for example, a daytime running light or a turn signal.

The second light-generating device 28 is arranged in the lighting device in such a way that, during operation of the lighting device, the light emitted by the second light-generating device 28 passes between the two U-legs 15 of the light guide 14 before it strikes the cover lens 12. FIG. 3 illustrates that the first light-generating device, designed in particular as a flat-light module, forms a luminous frame as a horizontally oriented U-shaped element, wherein the signal function of the second light-generating device 28 is arranged between the two U-legs 15.

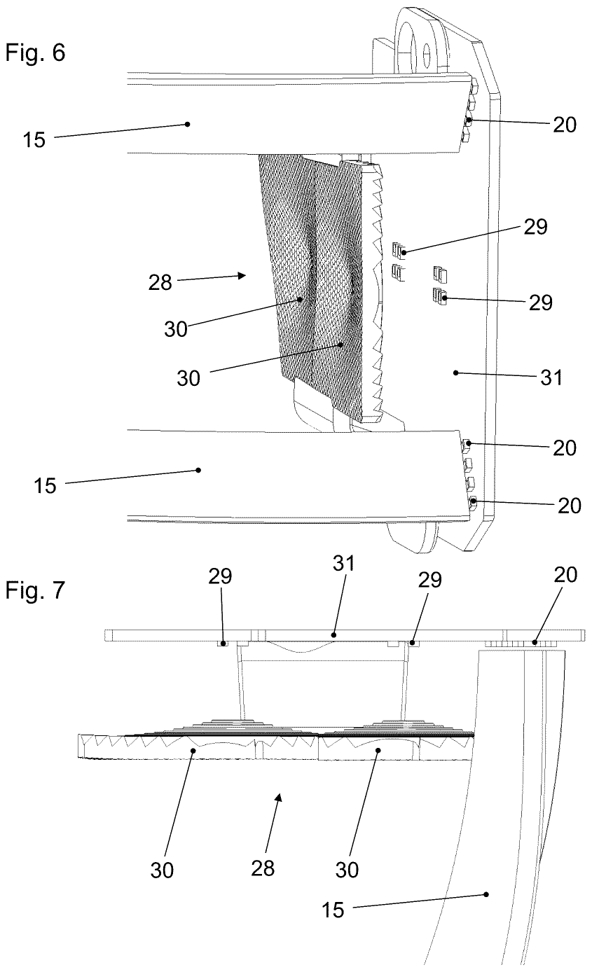

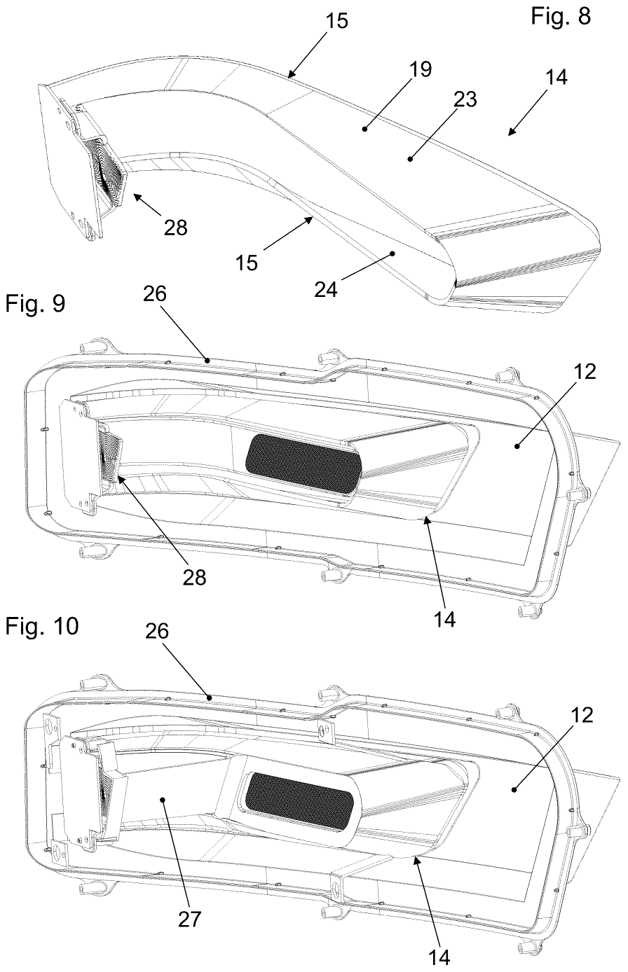

The second light-generating device 28 comprises a plurality of second light sources 29 designed as light-emitting diodes, and two lenses 30 designed as Fresnel lenses, in particular, as Typhoon lenses (see FIG. 6 and FIG. 7). Four second light sources 29 are assigned to each of the two lenses 30 in such a way that the light emitted by these four light sources 29 passes through the associated lens 30 before it strikes the cover lens 12. In each case, two of the four second light sources 29, which are assigned to one of the lenses 30, are designed as white light-emitting diodes and two further of the four second light sources 29 are designed as yellow light-emitting diodes. The first and the second light sources 20, 29 can be arranged on a common printed circuit board 31.

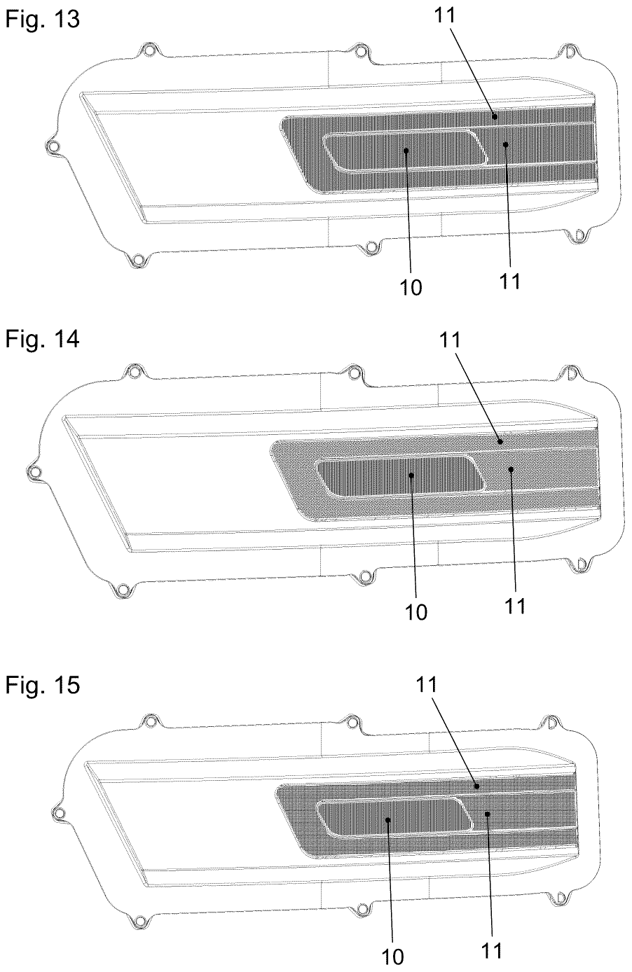

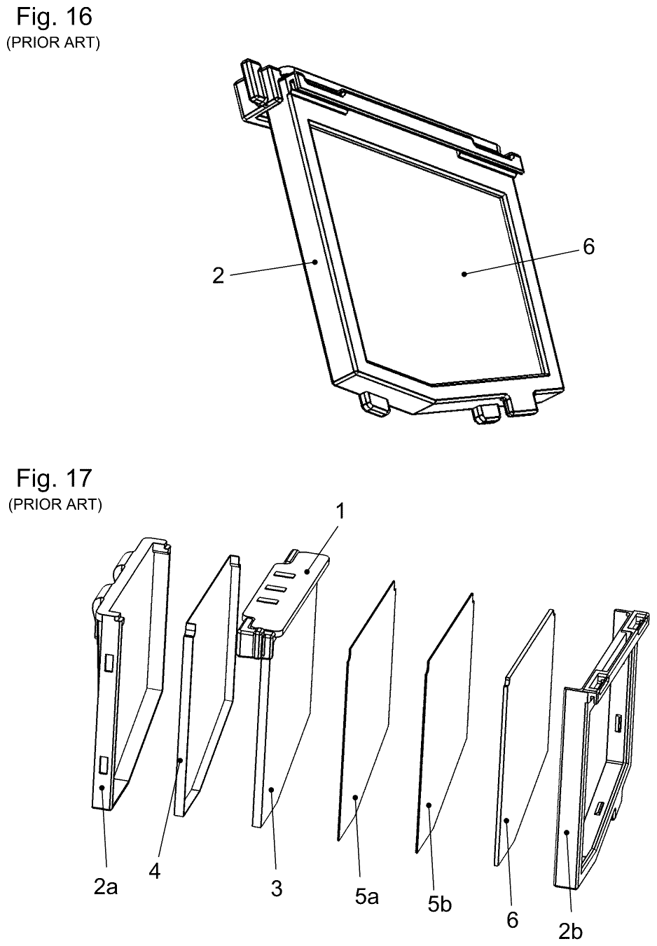

FIG. 12 illustrates the illuminated region 11 of the signal functions. This region frames an inner region 10 of a low-beam function, for which a micro-cylinder optic is required as a vertical strip optic. This micro-cylinder optic with pitches smaller than or equal to 0.5 mm, preferably in the range between 0.4 mm and 0.2 mm, can also be provided in the same way for the region 11 of the signal function, so that the entire region in the cover lens 12 is designed with a uniform, vertically oriented micro-strip optic (see FIG. 13).

Alternatively, the region 11 of the signal function can be designed with an optical structure, for example, a graining, etching, or erosion structure, or with a calculated diffuser structure, for example, designed as a laser structure, with a defined scattering (see FIG. 14).

Alternatively, the region 11 of the signal function can be designed with micro-optics in the form of small micro-cushion optics having a size of less than or equal to 1 mm, preferably less than or equal to 0.5 mm (see FIG. 15). These structures can be milled or laser-cut into a tool insert used in the manufacture of the cover lens 12 as an injection-molded plastic part.

### LIST OF REFERENCE NUMBERS

1 light source
2 housing
2a, 2b housing part
3 light guide
4 reflective film
5a, 5b optical component designed as a micro-optical film
6 cover lens
10 region for a main light function
11 region for a signal function
12 cover lens
13 recess in the cover lens
14 light guide
15 U-leg of the light guide
16 connecting portion of the light guide
17 end surface of the U-leg
18 narrow surface of the U-leg
19 wide surface of the U-leg
20 first light source
21 light emitted by the light source
22 entry surface of the light guide
23 first exit surface of the light guide
24 second exit surface of the light guide
25 density distribution of a structuring on the first exit surface
26 housing
27 rear cover
28 second light-generating device
29 second light source
30 lens of the second light-generating device
31 common circuit board for first and second light sources

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a motor vehicle, comprising:
a first light-generating device, wherein the first light-generating device has at least one first light source, a planar light guide with at least one entry surface and at least one exit surface, and at least one optical component;
a cover lens, wherein the lighting device is configured such that the light generated by the at least one first light source enters the light guide at least partially through the at least one entry surface, the light that has entered through the at least one entry surface exits at least partially from the at least one exit surface, the light exiting from the at least one exit surface of the light guide passes at least partially through the at least one optical component, is reflected by the at least one optical component, or both passes at least partially through the at least one optical component and is reflected by the at least one optical component, and the light exiting from the at least one exit surface of the light guide exits at least partially from the lighting device through the cover lens,
wherein the lighting device comprises at least one second light-generating device having at least one second light source, wherein the lighting device is configured such that the light emitted by the at least one second light-generating device exits the lighting device through the cover lens.

2. The lighting device according to claim 1, wherein the lighting device is configured such that the first light-generating device generates at least one first signal function, and the second light-generating device generates at least one second signal function.

3. The lighting device according to claim 1, wherein the second light-generating device has at least one lens, wherein the lighting device is configured such that the light generated by the at least one second light source passes through the at least one lens before exiting the lighting device through the cover lens.

4. The lighting device according to claim 1, wherein the second light-generating device has at least one reflector, wherein the lighting device is configured such that the light generated by the at least one second light source passes through the at least one reflector before it exits the lighting device through the cover lens.

5. The lighting device according to claim 1, wherein the second light-generating device has at least one light guide, wherein the lighting device is configured such that the light generated by the at least one second light source passes through the at least one light guide before it exits the lighting device through the cover lens.

6. The lighting device according to claim 1, wherein the cover lens has one or both of a micro-optics and a diffuser structure, wherein the lighting device is configured such that both the light emitted by the first light-generating device and the light emitted by the second light-generating device pass through one or both of the micro-optics and the diffuser structure.

7. The lighting device according to claim 1, wherein the light guide has curvatures in two different directions.

8. The lighting device according to claim 1, wherein the light guide has a structuring on its surface opposite the at least one exit surface, wherein the structuring is configured to cause or intensify a decoupling of the light that has entered through the at least one entry surface from the at least one exit surface, wherein the structuring has a density distribution, and wherein the density of the structuring on the surface opposite the at least one exit surface increases with increasing distance from the at least one entry surface.

9. The lighting device according to claim 1, wherein the light guide is substantially U-shaped, at least in sections, wherein the light guide has two U-legs and a connecting portion configured to connect the U-legs to one another, and wherein the two U-legs are spaced apart from one another.

10. The lighting device according to claim 9, wherein each of the U-legs of the light guide has, in sections, a longitudinal direction and a transverse direction perpendicular thereto, as well as a depth perpendicular to the longitudinal direction and to the transverse direction, wherein each of the U-legs of the light guide has a greater extent in the longitudinal direction than in the transverse direction and a greater extent in the transverse direction than in the depth perpendicular to the transverse direction, so that each of the U-legs of the light guide has an end surface at the end in the longitudinal direction, two narrow surfaces extending in sections in the longitudinal direction, and two wide surfaces extending in sections in the longitudinal direction.

11. The lighting device according to claim 9, wherein the light guide has at least two entry surfaces, wherein at least one of the entry surfaces is arranged on each of the U-legs.

12. The lighting device according to claim 11, wherein one of the entry surfaces is arranged in each case on the end surface of the U-leg facing away from the connecting portion, on the narrow surfaces extending in the longitudinal direction of the U-leg, or both on the end surface of the U-leg facing away from the connecting portion and on the narrow surfaces extending in the longitudinal direction of the U-leg.

13. The lighting device according to claim 9, wherein the second light-generating device is arranged in the lighting device in such a way that, during operation of the lighting device, the light emitted by the second light-generating device passes between the two U-legs of the light guide before it strikes the cover lens.

14. The lighting device according to claim 1, wherein the at least one optical component is designed as one or more of a microstructured film and as a microstructured optical disc, wherein the at least one microstructured film or the at least one microstructured optical disc is arranged between the light guide and the cover lens.

15. The lighting device according to claim 1, wherein the light guide has at least two exit surfaces, wherein a first of the exit surfaces faces away from the cover lens and a second of the exit surfaces faces the cover lens, wherein the at least one optical component is configured as an at least partially reflective surface that is arranged on the side of the light guide facing away from the cover lens, wherein the lighting device is configured such that light exiting from the first exit surface of the light guide strikes the reflective surface, is reflected back from the latter to the first exit surface, and at least partially re-enters the light guide before exiting from the second exit surface and passing through the cover lens.
